(19) United States
(12) Patent Application Publication
(10) Pub. No.: US 2004/0053638 A1
(43) Pub. Date: Mar. 18, 2004

(54) Computer network constructing method and computer network

(76) Inventors: Tadao Ohnaka, Kyoto (JP); Shinsuke Nagai, Gifu (JP); Masashi Iwai, Gifu (JP); Kazuhiro Yushina, Gifu (JP); Kenichiro Shimizu, Gifu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/451,158

(22) PCT Filed: Dec. 25, 2001
(86) PCT No.: PCT/JP01/11418

(30) Foreign Application Priority Data
Dec. 28, 2000 (JP) 2000-399892

(51) Int. Cl. H04Q 7/20

(52) U.S. Cl. 455/554.2; 455/561; 455/445

(57) ABSTRACT

A computer network which uses a community wiring for TV or wired broadcast and which is hardly influenced by disconnection, short-circuit and noise. The network is a coaxial cable network (1) which can transmit a mixed signal of the received signal of a receiver and a digital signal modulated into an RF signal. This coaxial cable network is provided with a signal input unit (2) for inputting a received signal into the coaxial cable network, and receivers (3a to 3c) and computers (4a to 4c) are connected with the coaxial cable network. Between the coaxial cable network and the computers, there are connected computer connection units (5a to 5c) for modulating a digital signal into an RF signal and for demodulating the RF signal into the digital signal.

### TECHNICAL FIELD

The present invention relates to a computer network constructing method using community wiring of TV, CATV, or the like and to the computer network.

### BACKGROUND OF THE INVENTION

A computer network using existing community wiring of a TV, a CATV, or the like routed in a building has been already proposed (refer to WO98/12838).

In the conventional computer network, however, a digital signal of a computer is mixed as it is with a received signal (RF analog signal) of a receiver and the mixed signal is transmitted into a cable network. Consequently, in the case where a capacitor or the like is disposed in the cable network or in the case where a cable is disconnected or short-circuited, a problem such that transmission of the signal of the computer is interrupted or a problem such that the computer network is easily disturbed by noise occurs.

### DISCLOSURE OF THE INVENTION

An object of the invention is therefore to provide a computer network which uses community wiring of a TV or wired broadcast and is hardly influenced by disconnection, short-circuit, and noise.

To achieve the object, the present invention provides a computer network constructing method comprising the steps of: providing a coaxial cable network capable of transmitting a mixed signal of a received signal of a receiver and a digital signal modulated to an RF signal; connecting at least one receiver and a plurality of computers to the coaxial cable network; modulating a digital signal from the computer into an RF signal, mixing the RF signal with the received signal of the receiver, and transmitting the mixed signal into the coaxial cable network; and demodulating the RF signal into the digital signal and outputting the digital signal to the computer side.

The receiver denotes here and in the following description a device having the function of receiving a signal from an input terminal and includes a receiver of a television, a CATV, wired broadcasting, or the like and a transceiver of a telephone, an interphone, or the like:

To achieve the object, the present invention provides a computer network comprising: a coaxial cable network capable of transmitting a mixed signal of a received signal of a receiver and a digital signal modulated to an RF signal; a signal input unit connected to the coaxial cable network for inputting the received signal into the coaxial cable network; at least one receiver connected to the coaxial cable network; a plurality of computer connection units connected to the coaxial cable network for modulating a digital signal into an RF signal and demodulating an RF signal into a digital signal; and a single computer connected to each of the plurality of computer connection units.

Preferably, the computer connection unit performs routing of data transmitted among the computers, so that a plurality of computers can be connected to the computer connection unit. The RF signal has, preferably, a frequency different from a frequency of the received signal.

Preferably, the computer network further comprises: at least one branching filter inserted in the coaxial cable network for branching the mixed signal into the received signal and the RF signal; an amplifier connected on the downstream side of the branching filter in the coaxial cable network for amplifying the received signal in the downlink direction from the branching filter; a bypass circuit connected in parallel with the amplifier on the downstream side of the branching filter in the coaxial cable network; and a mixer connected on the downstream side of the amplifier and the bypass circuit in the coaxial cable network for mixing a signal from the amplifier with the RF signal passed through the bypass circuit and retransmitting the mixed signal to the coaxial cable network.

Preferably, a router is connected to the coaxial cable network via the computer connection unit, thereby enabling communication with another computer network to be performed.

More preferably, the bypass circuit has a second amplifier capable of amplifying the RF signal in both uplink and downlink directions, and a carrier detector connected on the downstream side of the branching filter. The modem unit connected to the router has an oscillator. When a signal from the another computer network is converted to the RF signal and the RF signal is transmitted to the coaxial cable network, a carrier is transmitted from the oscillator to the coaxial cable network. When the carrier from the oscillator is detected by the carrier detector, the second amplifier operates so as to amplify only the RF signal in the downlink direction.

### BRIEF DESCRIPTION OF THE DRAWINGS

FIG. 1 is a block diagram showing a schematic configuration of a computer network according to an embodiment of the invention.

FIG. 2 is a block diagram showing a schematic configuration of a computer network according to another embodiment of the invention.

FIG. 3 is a block diagram showing a schematic configuration of a computer network according to further embodiment of the invention.

FIG. 4 is a block diagram illustrating the configuration of a bypass circuit in the computer network of FIG. 3 and an operation of controlling a transmitted signal between a router and the bypass circuit.

FIG. 5 is a diagram showing another circuit configuration of a second amplifier in FIG. 4.

FIG. 6 is a diagram showing a modification of a method of connecting a computer to a coaxial cable network, (A) shows a connecting method in the case where the computer performs wireless communication with a coaxial cable network at the same frequency as that of an RF signal transmitted into the coaxial cable network, and (B) shows a connecting method in the case where a computer performs wireless communication with a coaxial cable network at a frequency different from that of an RF signal transmitted into TV community wiring.

FIG. 7 is a block diagram schematically showing an example of the configuration of a computer connection unit used in the computer network of the invention.

### BEST MODE FOR CARRYING OUT THE INVENTION

Preferred embodiments of the invention will be described hereinbelow with reference to the attached drawings.

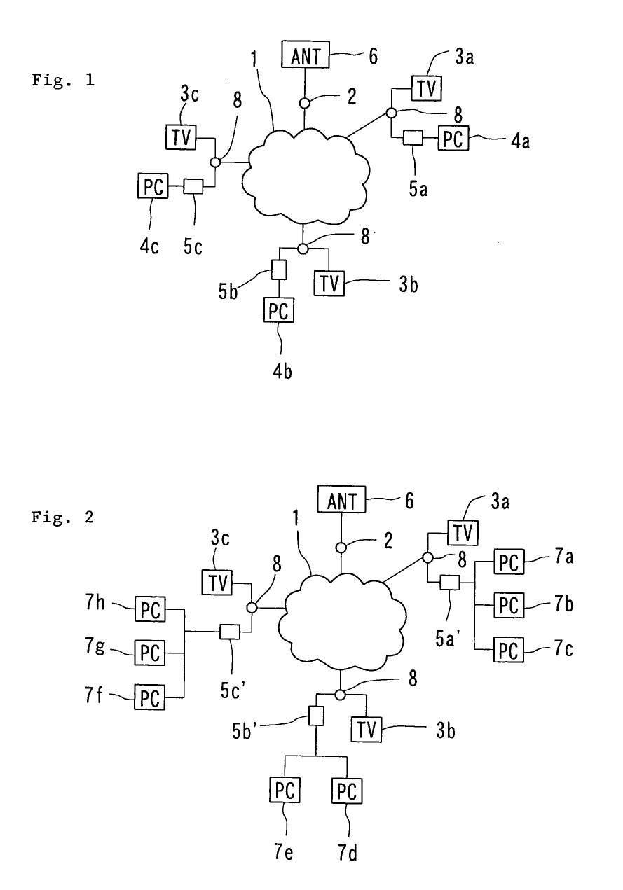

FIG. 1 is a block diagram showing a schematic configuration of a computer network according to an embodiment of the invention.

As shown in FIG. 1, the computer network according to the invention has a coaxial cable network 1 capable of transmitting a mixed signal of a received signal of a receiver and a digital signal modulated to an RF signal, and a signal input part 2 connected to the coaxial cable network 1 for inputting a received signal into the coaxial cable network 1.

To the coaxial cable network 1, pairs of receivers 3a-3c and computers 4a-4c are connected via distributors 8. Further, between the coaxial cable network 1 (distributors 8) and the computers 4a-4c, computer connection units 5a-5c are connected. The computer connection units 5a-5c function to modulate digital signals from the computers 4a-4c into RF signals, output the RF signals to the coaxial cable network 1 side, demodulate the RF signals from the coaxial cable network 1 into digital signals and output the digital signals to the side of the computers 4a-4c.

The term “receiver” implies here and in the following description a device having the function of receiving signals and includes, for example, a receiver of a television, a CATV, wired broadcasting, FM broadcasting, and the like and a transceiver of a telephone, an interphone, and the like.

In this case, received signals of a television include signals of VHF, UHF, BS, SHF, and CS. For transmission of the signals, the frequency band from 90 MHz to 2.15 GHz is divided and used. For transmission of a received signal of wired broadcasting, the frequency band from 28 MHz to 76 MHz is used. For transmission of a received signal of FM broadcasting, the frequency band from 76 MHz to 90 MHz is used.

Although the kinds of the coaxial cable network and the kinds of receivers are not particularly limited, in the embodiment, the coaxial cable network 1 is constructed by TV community wiring already routed in a building such as an apartment or an office building, and the receiver is a receiver of a television. To the signal input unit 2, a community reception antenna 6 of the television is connected.

Preferably, the RF signal obtained by modulating the digital signal has a frequency different from the frequency of the received signal.

In the case where a pair of a computer and a receiver is connected to a coaxial cable network as in the embodiment, a distributor is necessary. However, in the case where only a computer is connected to a coaxial cable network, the computer is directly connected to the coaxial cable network via a computer connection unit.

In the computer network of the invention, a digital signal of a computer is modulated to an RF signal, the RF signal is mixed with a received signal of a television receiver, and the mixed signal is transmitted into TV community wiring. Consequently, the computer network can be easily constructed by using existing TV community wiring. Also in the case where a capacitor or the like is disposed in the TV community wiring and even in the case where disconnection or short-circuit occurs in the TV community wiring, signal transmission of the computer is not easily disturbed. Moreover, a signal can be transmitted by the spread spectrum communication method or orthogonal frequency division multiplex method, so that the network is not easily influenced by noise. Therefore, stable communication among computers connected to the network is realized.

FIG. 2 is a block diagram showing a schematic configuration of a computer network according to another embodiment of the invention. The embodiment of FIG. 2 is different from that of FIG. 1 only in that a plurality of computers can be connected to each of the computer connection units. Therefore, the same components as those in the embodiment of FIG. 1 are designated by the same reference numerals and their description will not be repeated. In FIG. 2, three computers 7a-7c are connected to a computer connection unit 5a′, two computers 7d and 7e are connected to a computer connection unit 5b′, and three computers 7f-7h are connected to a computer connection unit 5c′. In this case, each of the computer connection units 5a′ to 5c′ functions to modulate a digital signal into an RF signal, demodulate the RF signal to a digital signal, and perform routing of data transmitted among the computers.

In the embodiment as well, effects similar to those of the embodiment of FIG. 1 are obtained. Moreover, a plurality of computers can be connected to a computer connection unit and data communication can be performed among the computers.

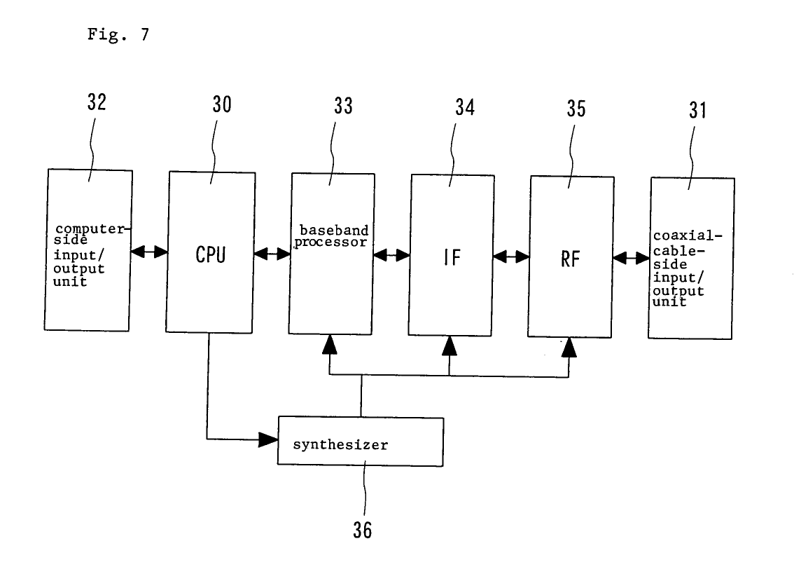

FIG. 7 is a block diagram schematically showing an example of the configuration of the computer connection unit. As shown in FIG. 7, the computer connection unit has a CPU (Central Processing Unit) 30, a coaxial-cable-side input/output unit 31 for inputting/outputting a signal from/to the coaxial cable network, a computer-side input/output unit 32 for inputting/outputting a signal from/to a computer, a baseband processor 33 for processing a baseband signal from the CPU 30 by, for example, the spread spectrum communication method, an IF amplifier 34 for modulating the baseband signal to an intermediate frequency, amplifying the intermediate frequency, and modulating the amplified signal to an RF signal, or for demodulating the RF signal to an intermediate frequency, amplifying the intermediate frequency, and demodulating the amplified signal to the baseband signal, an RF amplifier 35 for amplifying the input RF signal, and a synthesizer 36. The CPU 30 controls the synthesizer 36, IF amplifier 34, and RF amplifier 35 and performs routing of data transmitted among the computers.

The configuration of the computer connection unit is not limited to the above. It is sufficient to have a proper configuration so that the computer connection unit functions to modulate a digital signal into an RF signal, demodulate the RF signal into the digital signal, and perform routing of data passed among computers.

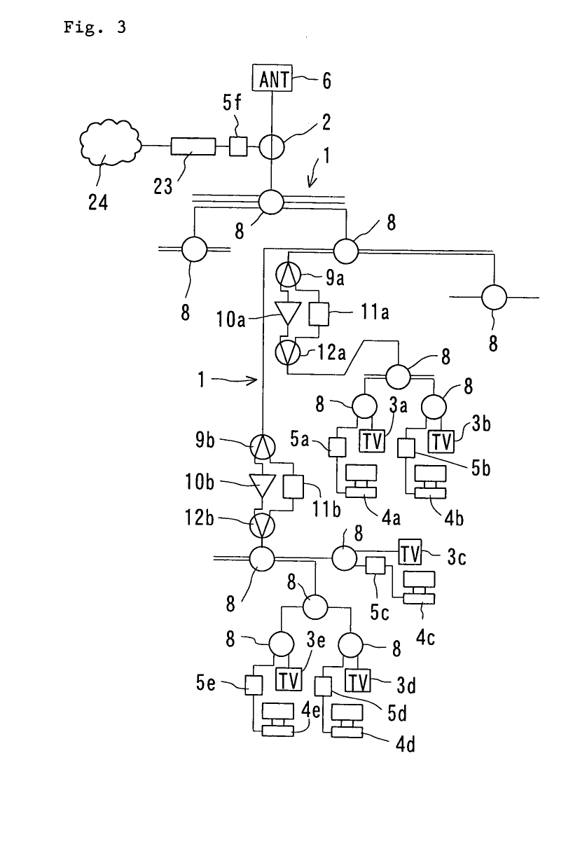

FIG. 3 is a block diagram showing a schematic configuration of a computer network according to further another embodiment of the invention. The embodiment of FIG. 3 is basically different from that of FIG. 1 only in that means for amplifying a received signal and an RF signal is provided in the TV community wiring (coaxial cable network) and in that another computer network is connected to the TV community wiring. The same components as those shown in FIG. 1 are designated by the same reference numerals and their detailed description will not be repeated.

As shown in FIG. 3, the computer network has: TV community wiring 1 capable of transmitting a mixed signal of a received signal of a receiver of a television and a digital signal modulated to an RF signal; the signal input unit 2 for inputting a received signal of the television into the TV community wiring 1; pairs of the receivers 3a-3e of televisions and computers 4a-4e connected to the TV community wiring 1 via distributors 8; and the computer connection units 5a-5e connected between the computers 4a-4e and the coaxial cable network 1 (distributors 8).

The computer network further includes: at least one of branching filters 9a and 9b inserted in the TV community wiring 1 and branching the mixed signal into the received signal and the RF signal; amplifiers 10a and 10b connected on the downstream side of the branching filters 9a and 9b, respectively, in the TV community wiring 1, for amplifying downlink received signals from the branching filters 9a and 9b; bypass circuits 11a and 11b connected in parallel to the amplifiers 10a and 10b, respectively, on the downstream side of the branching filters 9a and 9b in the TV community wiring 1; and mixers 12a and 12b which are connected on the downstream side of the amplifiers 10a and 10b and the bypass circuits 11a and 11b in the TV community wiring 1, for mixing signals from the amplifiers 10a and 10b with RF signals passed through the bypass circuits 11a and 11b and retransmitting the mixed signals to the TV community wiring 1.

A router 23 is connected to the signal input unit 2 of the TV community wiring 1 via a computer connection unit 5f. To the router 23, another computer network 24 (for example, LAN, WAN, Internet, or the like) is connected. Although the computer connection unit 5f and the router 23 are connected to the signal input unit 2 in the embodiment, they may be connected in proper position other than the signal input unit 2 in the TV community wiring 1.

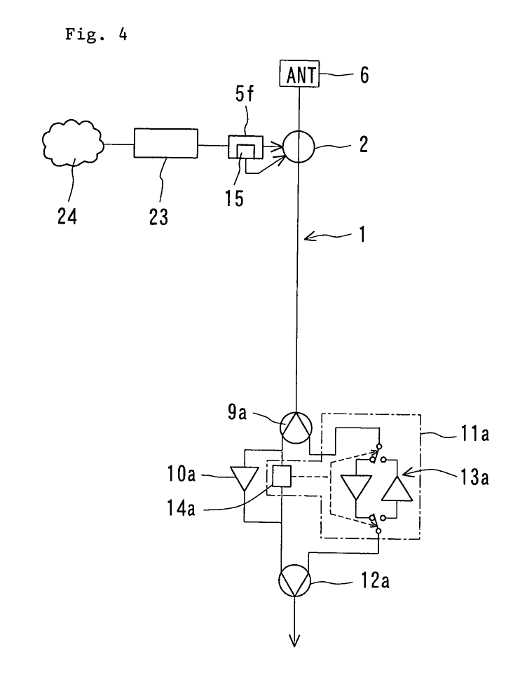

FIG. 4 is a block diagram showing the configuration of a bypass circuit in the computer network of FIG. 3 and an operation of controlling a transmitted signal between the router 23 and the bypass circuit. Although one of the bypass circuits of FIG. 3 is shown as a representative example in FIG. 4, the following description is also applied to the other bypass circuits. As shown in FIG. 4, the bypass circuit 11a has a second amplifier 13a capable of amplifying both uplink and downlink RF signals, and a carrier detector 14a connected on the output side of the received signal in the branching filter 9a.

The computer connection unit 5f to which the router 23 is connected has an oscillator 15. When a signal from another computer network 24 is converted to an RF signal and the RF signal is transmitted to the TV community wiring 1, a carrier is transmitted from the oscillator 15 to the TV community wiring 1. When the carrier from the oscillator 15 is detected by the carrier detector 14a, the second amplifier 13a operates to amplify only the downlink RF signal. It prevents the second amplifier 13a from oscillating.

In the embodiment, the carrier transmitted from the oscillator 15 is set to have a frequency near the frequency of a received signal of a television. The frequency of the carrier can be also set around the frequency of the RF signal. In the latter case, the carrier detector 14a is connected to the output side of an RF signal of the branching filter 9a.

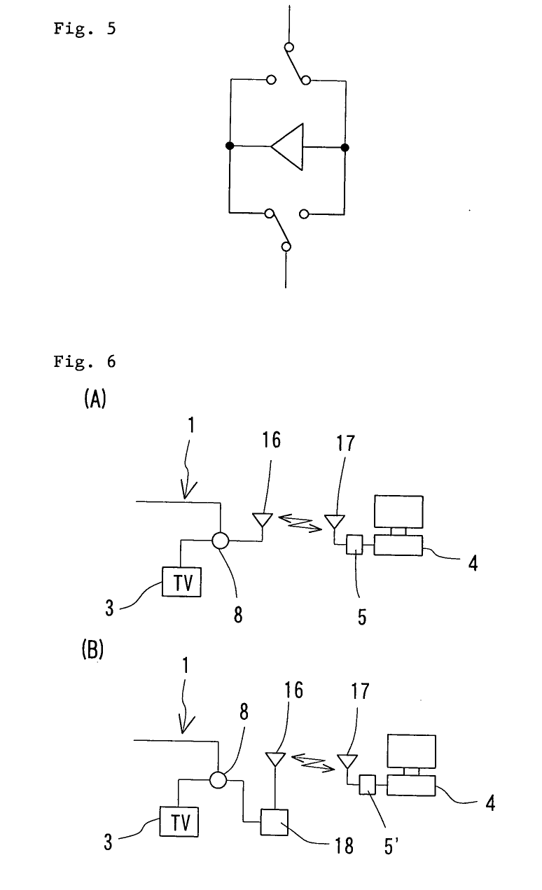

The circuit configuration of the second amplifier of the bypass circuit, capable of amplifying both uplink and downlink RF signals is not limited to that of the embodiment but can be like, for example, that shown in FIG. 5. In the embodiment, the bypass circuit includes the amplifier capable of amplifying the RF signal in both directions. In the case where it is unnecessary to amplify the RF signal, the bypass circuit can be also constructed only by a single coaxial cable.

In the embodiment, effects similar to those of the embodiment of FIGS. 1 and 2 are obtained. Further, by providing the amplifier for amplifying the received signal and the RF signal in the TV community wiring, attenuation of a transmitted signal is prevented. Even when the TV community wiring extends long, high-quality and stable communication can be achieved and stable data communication with another computer network can be realized.

The frequency of the RF signal can be set to an arbitrary frequency as long as it is different from that of a received signal of a television (received signal of a receiver).

Although the computer is connected to the coaxial cable network (TV community wiring) in the foregoing embodiments, the computer and the coaxial cable network can be also connected to each other wirelessly. For example, when the frequency of the RF signal transmitted in the coaxial cable network and the frequency of wireless transmission between the coaxial cable network and the computer are set to the same, preferably, 2.4 GHz (frequency used in the wireless LAN), as shown in FIG. 6A, a first antenna 16 is connected to the distributor 8 of the coaxial cable network 1 and a second antenna 17 for performing wireless communication with the first antenna 16 is connected to the computer connection unit 5, thereby enabling communication to be performed without connecting the computer 4 to the coaxial cable network. In the case where the frequency of the RF signal transmitted in the coaxial cable network and the frequency of wireless transmission between the coaxial cable network and the computer are set differently, for example, an RF signal of 900 MHz is transmitted into the coaxial cable network. When a signal of 2.4 GHz is transmitted between the coaxial cable network and the computer, as shown in FIG. 6B, an updown converter 18 is connected between the distributor 8 and the first antenna 16 and the function of an updown converter is added to the computer connection unit 5′ so that the signal of 900 MHz and the signal of 2.4 GHz are converted to each other, thereby enabling communication to be performed without connecting the computer 4 to the coaxial cable network.

The invention can be also applied to an optical fiber network. This can be basically realized by, in the foregoing embodiments, using an optical fiber network in place of the TV community wiring (coaxial cable network) and disposing an optical signal/electric signal converter in each of the connection portion between the signal input unit and the optical fiber network and the connection portion between the distributor to which the receiver of the television and the modem unit are connected and the optical fiber network.

Industrial Applicability

As described above, according to the invention, a digital signal of a computer is modulated to an RF signal, the RF signal is mixed with a received signal of a receiver, and the mixed signal is transmitted into a coaxial cable network, so that the computer network can be easily constructed by using the coaxial cable network of an existing receiver. According to the invention, also in the case where a capacitor or the like is inserted in the coaxial cable network or in the case where disconnection or short-circuit occurs in the coaxial cable network, transmission of a signal of the computer is not easily interrupted. Further, the digital signal is modulated into the RF signal and the RF signal is transmitted, so that the signal can be transmitted by the spread spectrum communication method or the orthogonal frequency division multiplex method, and the computer network which is not vulnerable to an influence of noise can be constructed.

1. A computer network constructing method comprising the steps of:
providing a coaxial cable network capable of transmitting a mixed signal of a received signal of a receiver and a digital signal modulated to an RF signal;
connecting at least one receiver and a plurality of computers to said coaxial cable network;
modulating a digital signal from the computer into an RF signal, mixing the RF signal with the received signal of the receiver, and transmitting the mixed signal into said coaxial cable network; and
demodulating said RF signal into said digital signal and outputting said digital signal to the computer side.

2. A computer network comprising:
a coaxial cable network capable of transmitting a mixed signal of a received signal of a receiver and a digital signal modulated to an RF signal;
a signal input unit connected to said coaxial cable network for inputting said received signal into said coaxial cable network;
at least one receiver connected to said coaxial cable network;
a plurality of computer connection units connected to said coaxial cable network for modulating a digital signal into an RF signal and demodulating an RF signal into a digital signal; and
a single computer connected to each of said plurality of computer connection units.

3. The computer network according to claim 2, wherein said computer connection unit performs routing of data transmitted among the computers, so that a plurality of computers can be connected to said computer connection unit.

4. The computer network according to claim 2 or 3, wherein said RF signal has a frequency different from a frequency of said received signal.

5. The computer network according to any one of claims 2 to 4, further comprising:
at least one branching filter inserted in said coaxial cable network for branching said mixed signal into said received signal and said RF signal;
an amplifier connected on the downstream side of said branching filter in said coaxial cable network for amplifying said received signal in the downlink direction from said branching filter;
a bypass circuit connected in parallel with said amplifier on the downstream side of said branching filter in said coaxial cable network; and
a mixer connected on the downstream side of said amplifier and said bypass circuit in said coaxial cable network for mixing a signal from said amplifier with said RF signal passed through said bypass circuit and retransmitting the mixed signal to said coaxial cable network.

6. The computer network according to any one of claims 2 to 5, wherein another computer network is connected via a router to said computer connection unit.

7. The computer network according to claim 6, wherein said bypass circuit has a second amplifier capable of amplifying said RF signal in both uplink and downlink directions, and a carrier detector connected on the downstream side of said branching filter,
said computer connection unit to which said router is connected has an oscillator,
when a signal from said another computer network is converted to said RF signal and said RF signal is transmitted to said coaxial cable network, a carrier is transmitted from said oscillator to said coaxial cable network, and
when said carrier from said oscillator is detected by said carrier detector, said second amplifier operates so as to amplify only said RF signal in the downlink direction.
